(19) United States
(12) Patent Application Publication
(10) Pub. No.: US 2026/0348615 A1
(43) Pub. Date: Nov. 5, 2026

(54) VALVE ASSEMBLY FOR AC CONDENSATE LINE

(71) Applicant: Frank Joseph Hartland, Englewood, FL (US)

(72) Inventor: Frank Joseph Hartland, Englewood, FL (US)

(21) Appl. No.: 19/735,023

(22) Filed: Jul. 8, 2026

Related U.S. Application Data
(63) Continuation of application No. 18/746,284, filed on Jun. 18, 2024.
(60) Provisional application No. 63/610,003, filed on Dec. 14, 2023.

(51) Int. Cl. F24F 13/22; B08B 9/032

(52) U.S. Cl. CPC F24F 13/222; B08B 9/0321; F24F 2013/227; F24F 2221/225; Y10T 137/4259

(57) ABSTRACT

The present disclosure discloses a valve assembly. The valve assembly includes a tee shaped structure configured to receive water from a garden hose and an air conditioner condensate line, and configured to output the water to a drain line. The valve assembly further includes one or more valves disposed on the tee shaped structure. The valves are configured to regulate a flow of water to the drain line from the garden hose and/or the air conditioner condensate line.

### CROSS-REFERENCE TO RELATED APPLICATION

This application is a continuation of U.S. application Ser. No. 18/746,284, filed Jun. 18, 2024, which claims the benefit of priority of U.S. Provisional Application No. 63/610,003, filed Dec. 14, 2023, the contents of each of which are herein incorporated by reference in their entirety.

### BACKGROUND OF THE INVENTION

The present invention relates generally to a valve assembly for an air conditioning condensate line, and more particularly to a valve assembly that allows the user to flush their air conditioning condensate line with a garden hose without flooding the air handler.

Over time, air conditioner condensate lines fill with mold growth, which ultimately leads to the drain line backing up with water. This stops the air conditioner from working properly and causes frustration and discomfort for the user until the issue is resolved. Often, the blockage is halfway down the line and is extremely difficult to unclog without specialty tools.

Therefore, a system is required that enables a user to conveniently and easily unclog the air conditioner condensate line.

### SUMMARY OF THE INVENTION

The following presents a simplified summary of the present disclosure in a simplified form as a prelude to the more detailed description that is presented herein.

In accordance with preferred embodiments of the present invention, there is provided a valve assembly. The valve assembly includes a tee shaped structure configured to receive water from a garden hose and an air conditioner condensate line configured to output the water to a drain line. The valve assembly further includes one or more valves disposed on the tee shaped structure. The valves are configured to regulate the flow of water to the drain line from the garden hose and/or the air conditioner condensate line.

The valve assembly, as disclosed in the present disclosure, attaches to the condensate line, and allows the user to attach a garden hose onto the condensate line. Once turned on, the hose flushes out all blockages and debris quickly and without the need for specialty tools or technicians.

These and other features, aspects, and advantages of the present invention will become better understood with reference to the following description.

### BRIEF DESCRIPTION OF THE DRAWINGS

FIG. 1 is a perspective view of a valve assembly for an AC condensate line in accordance with a preferred embodiment of the present invention;

FIG. 2 is an exploded view of the valve assembly of FIG. 1;

FIG. 3 is a cross-sectional view of the valve assembly taken along line 3-3 of FIG. 1; and

FIG. 4 is a cross-sectional view of the valve assembly taken along line 3-3 of FIG. 1 showing motion of the ball valve and the garden hose valve.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a valve assembly for an AC condensate line, and more particularly to a valve assembly that allows the user to flush their air conditioning condensate line with a garden hose without flooding the air handler.

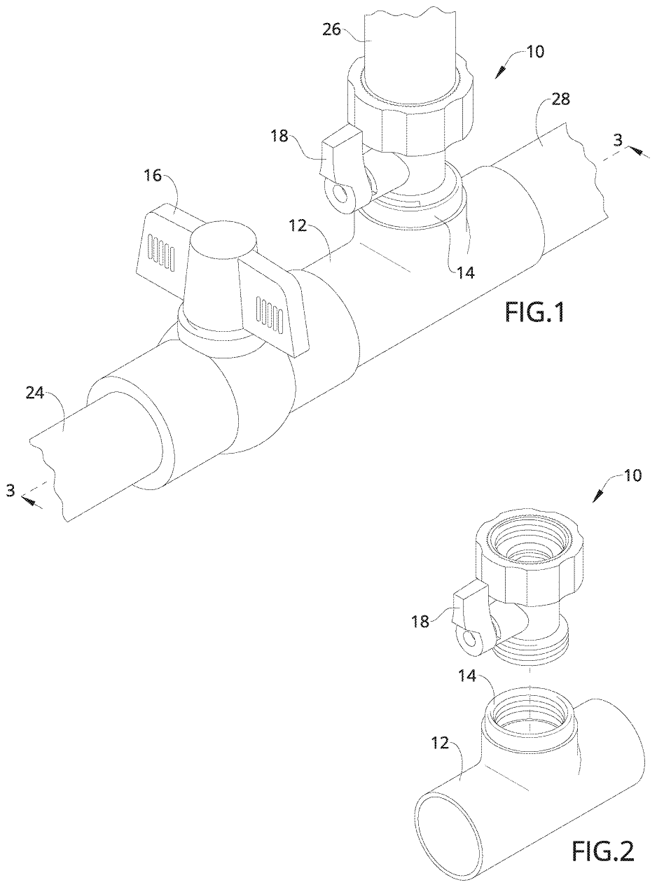

FIG. 1 depicts a perspective view of a valve assembly 10 (or tee assembly) in accordance with preferred embodiments of the invention. FIG. 1 will be described in conjunction with FIGS. 2, 3 and 4. The valve assembly 10 (or assembly 10) includes a tee 12, an insert 14, and a garden hose valve 18. The assembly 10 may be attached with an air handler drain line 24 via a coupling 20. The coupling 20 may include a ball valve 16. The assembly 10 may be further attached with a garden hose line 26 and a drain exit line 28.

The components required to make the assembly 10 include a brass ball valve 18, with male to female threads (garden hose thread, seen in FIG. 2 by way of example), Teflon thread sealing tape, custom PVC tee 12 with slip fittings on 2 sides and garden hose thread metal insert 14 at the top section, 0.5 to 1.5 inch piece of schedule 40 PVC pipe, and 0.75 inch schedule 40 slip ball valve 18.

To make the assembly 10, the Teflon tape is applied to the male end of the brass valve 18 and threaded into the custom PVC tee 12. Then the piece of 0.5 to 1.5 inch piece of schedule 40 PVC pipe is attached to both the 0.75 inch schedule 40 slip ball valve 18 and the custom PVC tee.

During installation of the assembly 10, an approximately six inch piece is cut out and removed from the user's existing AC condensate line 24. This cut is made as close as possible to the air handler (not shown). Using PVC glue, the assembly 10 is attached to the condensate line 24 where the pipe was removed and therefore becomes part of the AC drain line 28. The assembly 10 must be installed with a PVC ball valve 16 on the side of the condensate line closest to the air handler.

Once installed, the user flushes their AC drain line 28 as follows: Firstly, the user turns off the AC system. The user then attaches the garden hose (turned off) to brass valve 18 of assembly 10. The user then turns the PVC ball valve 16 to its closed position. The user then turns the brass valve 18 to its “Open” position. The user then turns the water on to garden hose 26. The user then allows blockage to unclog until clear water runs smoothly out of condensate line 28. Thereafter, the user turns off the garden hose 26. The user then removes the garden hose 26 from assembly 10. The user then turns the brass valve 18 to the “Closed” position. The user then turns the PVC ball valve 16 to the “Open” position and turns the AC system back on.

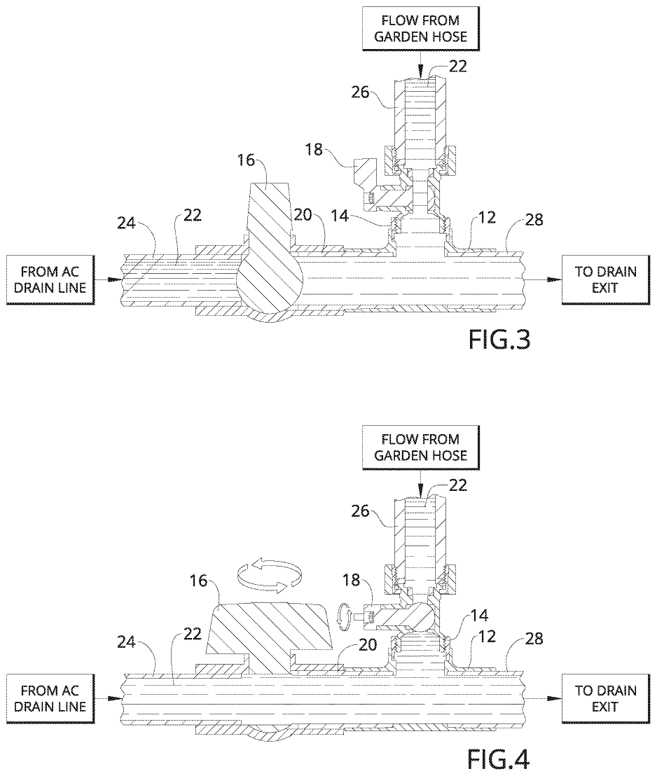

As shown in FIG. 3, when the ball valve 16 is closed and the garden hose valve 18 is open, water 22 flows from the garden hose 26 towards the drain exit line 28, thereby unclogging the AC condensate line. In this arrangement, the water 22 from the coupling 20 does not flow towards the drain exit line 28. On the other hand, as shown in FIG. 4, when the ball valve 16 is open and the garden hose valve 18 is closed, the water 22 flows from the coupling 20 towards the drain exit line 28 (and not from the garden hose towards the drain exit line 28).

In some aspects, the brass valve 18 may be replaced with a fixed garden hose fitting and a cap, rather than a valve. The brass valve 18 may further be replaced with a plastic version. The custom tee 12 may be replaced with an off-the-shelf version. However, the function remains the same. There must be a valve to stop water flowing back to the air handler, and a hose connection in front of it to allow the water to flow through the line under pressure.

The assembly 10 could also be used in irrigation systems to unclog sediment filled pipes. The assembly 10 could also be used to put bleach, vinegar or other chemicals into the condensate line, through the brass fitting.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

It should be understood, of course, that the foregoing relates to exemplary embodiments of the invention and that modifications may be made without departing from the spirit and scope of the invention as set forth in the following claims.

What is claimed is:

1. A condensate drain line service assembly for installation inline in a condensate drain line of an HVAC system, the assembly comprising:
a tee fitting having a body defining an upstream inlet, a downstream outlet, and a branch port, the upstream inlet and the downstream outlet defining a primary condensate flow path through the body, and the branch port extending transverse to the primary condensate flow path;
a hose connector at the branch port configured to releasably receive a pressurized external fluid supply;
a first shut-off valve disposed in the primary condensate flow path between the upstream inlet and an air handler, the first shut-off valve being configured to selectively interrupt condensate flow between the air handler and the tee fitting; and
a second shut-off valve disposed at the branch port and configured to selectively seal the branch port;
wherein, in a first operating mode, the first shut-off valve is open and the second shut-off valve is closed such that condensate flows from the air handler through the upstream inlet, through the primary condensate flow path, and out the downstream outlet; and
wherein, in a second operating mode, the first shut-off valve is closed and the second shut-off valve is open such that fluid from the external fluid supply enters through the branch port, passes through the primary condensate flow path, and exits through the downstream outlet to flush the condensate drain line without directing fluid toward the air handler.

2. The condensate drain line service assembly of claim 1, wherein the tee fitting is a unitary rigid body having exactly three openings consisting of the upstream inlet, the downstream outlet, and the branch port.

3. The condensate drain line service assembly of claim 1, wherein the branch port extends substantially perpendicularly to the primary condensate flow path.

4. The condensate drain line service assembly of claim 1, wherein the branch port comprises a threaded insert fixedly embedded in the body of the tee fitting, the threaded insert being configured to directly receive a threaded end of the second shut-off valve without the use of adapters.

5. The condensate drain line service assembly of claim 4, wherein the threaded insert is a metal insert.

6. The condensate drain line service assembly of claim 5, wherein the threaded insert has garden hose thread (GHT) configured to directly receive a male GHT end of the second shut-off valve.

7. The condensate drain line service assembly of claim 6, wherein the second shut-off valve is a ball valve having:
a tee-facing end with male garden hose thread (GHT) threadedly engaged with the GHT of the threaded insert; and
a hose-facing end with female garden hose thread (GHT) configured to threadedly receive a standard garden hose.

8. The condensate drain line service assembly of claim 7, wherein the second shut-off valve is a brass ball valve.

9. The condensate drain line service assembly of claim 1, wherein the second shut-off valve, when in the closed position, forms an air-tight seal at the branch port sufficient to maintain negative pressure integrity of the condensate drain line during normal HVAC operation.

10. The condensate drain line service assembly of claim 1, wherein the first shut-off valve is permanently joined to the upstream inlet of the tee fitting.

11. The condensate drain line service assembly of claim 1, wherein the tee fitting is a PVC fitting.

12. The condensate drain line service assembly of claim 11, wherein the tee fitting is a Schedule 80 PVC fitting.

13. The condensate drain line service assembly of claim 11, wherein the first shut-off valve is a Schedule 40 PVC slip ball valve solvent-welded to the upstream inlet of the tee fitting on an air-handler side thereof.

14. A tee fitting for a condensate drain line service assembly, comprising:
a rigid body having an upstream inlet, a downstream outlet, and a branch port, the upstream inlet and the downstream outlet defining a primary fluid flow path through the body, and the branch port extending transverse to the primary fluid flow path; and
a threaded insert fixedly embedded in the body at the branch port, the threaded insert being configured to directly receive a threaded end of a shut-off valve without the use of adapters.

15. The tee fitting of claim 14, wherein the body is a unitary body having exactly three openings consisting of the upstream inlet, the downstream outlet, and the branch port, and wherein the branch port extends substantially perpendicularly to the primary fluid flow path.

16. The tee fitting of claim 14, wherein the threaded insert is a metal insert having garden hose thread (GHT) fixedly embedded in a Schedule 80 PVC body by co-molding, the GHT being configured to directly receive a male GHT end of a brass ball valve without adapters.

17. A method of servicing a condensate drain line of an HVAC system, comprising:
providing, inline in the condensate drain line, a tee fitting having an upstream inlet connected to the condensate drain line on an air-handler side, a downstream outlet connected to the condensate drain line on a drain side, a branch port extending transverse to a primary condensate flow path defined between the upstream inlet and the downstream outlet, and a hose connector at the branch port;
closing a first shut-off valve positioned in the primary condensate flow path between the tee fitting and the air handler, thereby blocking condensate flow from the air handler;
opening a second shut-off valve at the branch port;
connecting a pressurized external fluid supply to the hose connector;
flowing pressurized fluid from the external fluid supply through the branch port and through the tee fitting into the condensate drain line downstream of the tee fitting, thereby flushing the condensate drain line; and
thereafter, closing the second shut-off valve, opening the first shut-off valve, and disconnecting the external fluid supply to restore normal condensate flow from the air handler through the primary condensate flow path to the downstream outlet.

18. The method of claim 17, wherein closing the second shut-off valve forms an air-tight seal at the branch port that maintains negative pressure integrity of the condensate drain line during normal HVAC operation.

19. The method of claim 17, wherein the external fluid supply is a standard garden hose, and the hose connector is configured to directly receive the garden hose.

20. The method of claim 17, wherein flowing pressurized fluid comprises introducing at least one of water, a cleaning agent, an antimicrobial solution, or a chemical treatment into the condensate drain line through the branch port.
